(19) United States
(12) Patent Application Publication
(10) Pub. No.: US 2016/0291877 A1
(43) Pub. Date: Oct. 6, 2016

(54) STORAGE SYSTEM AND DEDUPLICATION CONTROL METHOD

(71) Applicants: Hitachi, Ltd., Tokyo (JP); Hitachi Information & Telecommunication Engineering Ltd., Yokohama-shi, Kanagawa (JP)

(72) Inventors: Tomoki HIGUCHI, Kanagawa (JP); Mikito OGATA, Kanagawa (JP); Hidehisa ARIKAWA, Kanagawa (JP)

(21) Appl. No.: 14/771,621

(22) PCT Filed: Dec. 24, 2013
(86) PCT No.: PCT/JP2013/084519

§ 371 Date: Aug. 31, 2015

(51) Int. Cl. G06F 3/06

(52) U.S. Cl. CPC G06F 3/0608; G06F 3/065; G06F 3/0641; G06F 3/067; G06F 3/0619

(57) ABSTRACT

A storage system divides a file into large chunks, executes primary deduplication processing (a first step in deduplication processing) to perform deduplication on the large chunks regardless of a file format, divides at least one large chunk into small chunks, and does not execute secondary deduplication processing (a second step in the deduplication processing) to perform deduplication on the small chunks when the file format satisfies a predetermined condition but executes the secondary deduplication processing when the file format does not satisfy the predetermined condition.

### TECHNICAL FIELD

This invention generally relates to storage control and, for example, relates to deduplication of data.

### BACKGROUND ART

For example, PTL 1 and NPL 1 related to deduplication of data have been known.

PTL 1 discloses a technique of using both a post-process system and an in-line system. The post-process system is a system in which data is written to a storage device and then asynchronous deduplication processing is executed on the data. The in-line system is a system in which the deduplication processing is executed on data before the data is written to a storage device.

NPL 1 discloses a technique of executing the deduplication processing in multiple stages. In first stage deduplication processing, data is divided into large chunks, and the deduplication is executed on the large chunks. In second stage deduplication processing, the large chunks are divided into small chunks, and the deduplication is executed on the small chunks.

### CITATION LIST

### Patent Literature

[PTL 1]

US Patent Application Publication No. 2011/0289281

### Non Patent Literature

[NPL 1]

M. Ogata, N. Komoda, “Improvement of performance and reduction in deduplication backup system using multiple layered architecture”, The first Asian Conference on Information Systems, in Proceedings of ACIS2012, Dec. 2012

### SUMMARY OF INVENTION

### Technical Problem

In NPL 1, there is a problem in that the size of a load, due to the deduplication processing, might overwhelm the effectiveness of the deduplication achieved by the two-stage deduplication processing.

In PTL 1, where one of synchronous deduplication processing (in-line system) and asynchronous deduplication processing (post-process system) is executed on a single file, there is a problem in that a larger file dividing size (chunk size) leads to a lower deduplication effect and a smaller file dividing size leads to a larger load due to the deduplication processing.

### Solution to Problem

A storage system divides a file into large chunks, executes primary deduplication processing (a first step in deduplication processing) to perform deduplication on the large chunks regardless of a file format, divides at least one large chunk into small chunks, and executes secondary deduplication processing (second step in the deduplication processing) to perform deduplication on the small chunks not when the file format satisfies a predetermined condition but when the file format does not satisfy the predetermined condition.

### Advantageous Effects of Invention

For each file, whether deduplication processing is executed in a single stage or in multiple stages (at least two stages) can be appropriately controlled. Thus, high deduplication effect can be achieved with a small load for the deduplication processing, whereby both reduction in a consumed capacity in a storage area and performance improvement can be achieved.

### BRIEF DESCRIPTION OF DRAWINGS

FIG. 1 illustrates an overview of a storage system according to an embodiment.

FIG. 2 is a diagram illustrating a hardware configuration of a system according to the embodiment.

FIG. 3 is a block diagram illustrating a function of a storage system according to the embodiment.

FIG. 4A illustrates a configuration of metadata 12A.

FIG. 4B illustrates a configuration of metadata 12B.

FIG. 5 illustrates an overview of synchronous processing.

FIG. 6 illustrates an overview of first asynchronous processing.

FIG. 7 illustrates an overview of second asynchronous processing.

FIG. 8 illustrates a flow of backup processing.

FIG. 9 illustrates a flow of the synchronous processing.

FIG. 10 illustrates a flow of the first asynchronous processing.

FIG. 11 illustrates a flow of the second asynchronous processing.

FIG. 12 illustrates a flow of migration processing corresponding to the first asynchronous processing.

FIG. 13 illustrates a flow of migration processing corresponding to the second asynchronous processing.

FIG. 14 illustrates a flow of second deduplication processing executed by a secondary deduplication unit that has received a large chunk.

### DESCRIPTION OF EMBODIMENTS

One embodiment is described below.

In the following description, the term “xxx table” is used for describing information, which can be represented by any data structure. In other words, a “xxx table” can be referred to as “xxx information” to show independence of the information from data structures.

In the following description, although a “program” may be a subject of performing processing, because the program is executed by a processor performing predetermined processing using a memory and a communication port (communication interface device), the processor can be a subject of performing such processing. Furthermore, processing disclosed to be performed by a program may be processing performed by an apparatus such as a computer. The processor is typically a microprocessor that performs the program or its core, and may include special purpose hardware that performs part of the processing. Various types of programs may be installed in a computer through a program distribution server or a computer readable storage medium.

In the following description, “VOL” stands for a logical volume and means a logical storage device. The VOL may be a real VOL (RVOL) or a virtual VOL (VVOL). The VOL may be an online VOL provided to a host apparatus coupled to a storage apparatus to which the VOL is to be provided, or an offline VOL not provided to the host apparatus (not recognized by the host apparatus). The “RVOL” is a VOL based on a physical storage resource (for example, a RAID (Redundant Array of Independent (or Inexpensive) Disks) group composed of a plurality of PDEVs) included in the storage apparatus that has the RVOL. The “VVOL” may be, for example, an external connection VOL (EVOL) that is a VOL based on a storage resource (for example, VOL) included in an external storage apparatus coupled to the storage apparatus that has the VVOL and compliant with a storage virtualization technique, a VOL (TPVOL) composed of a plurality of virtual pages (virtual storage areas) and compliant with a capacity virtualization technique (typically, thin provisioning), and a snapshot VOL provided as a snapshot of an original VOL. The TPVOL is typically an online VOL. The snapshot VOL may be an RVOL. “PDEV” stands for a non-volatile physical storage device. A plurality of PDEVs may form a plurality of RAID groups. The RAID groups may be referred to as a parity group. “Pool” is a logical storage area (for example, a group of a plurality of pool VOLs) and may be provided for each application. Examples of the pool may include a TP pool and a snapshot pool. The TP pool is a storage area composed of a plurality of real pages (real storage areas). A real page may be assigned from the TP pool to a TPVOL virtual page. The snapshot pool may be a storage area that stores data saved from the original VOL. The “pool VOL” is a VOL included in a pool. The pool VOL may be an RVOL or an EVOL. The pool VOL is typically an offline VOL.

The following description employs a file system as an example of a storage area. The file system is an example of a logical storage area and is a VOL, for example.

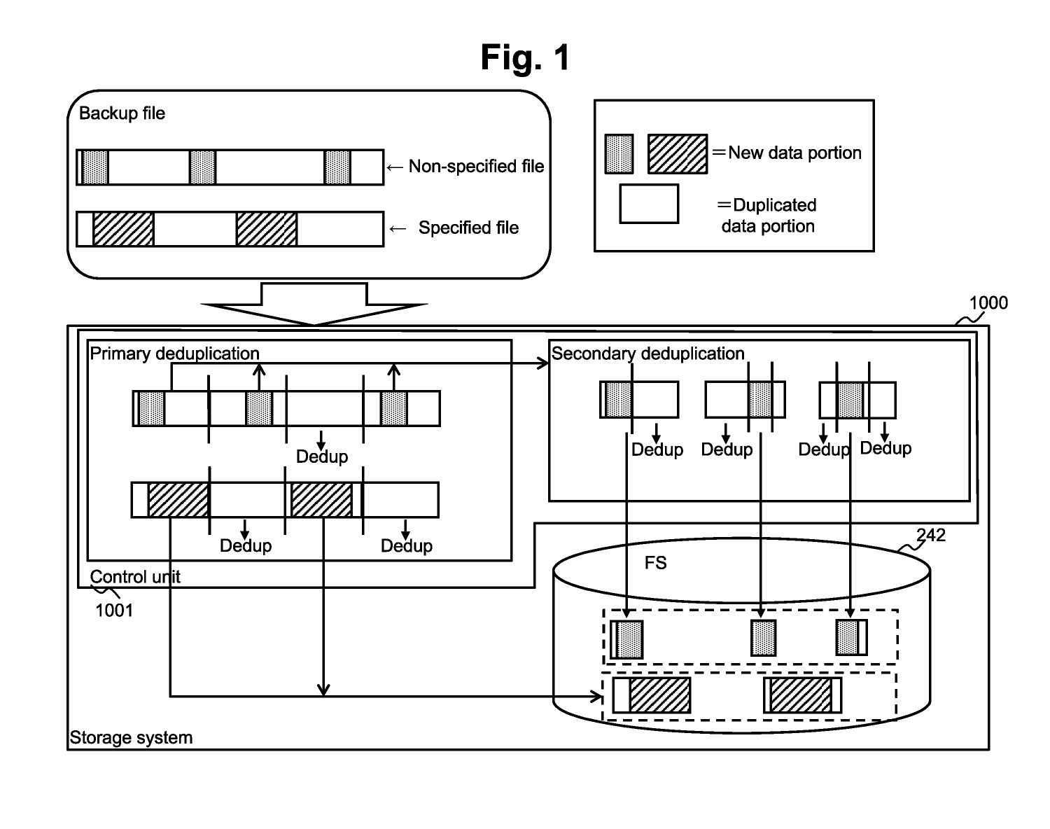

FIG. 1 illustrates an overview of a storage system according to an embodiment.

A storage system 1000 includes a file system (“FS” in the FIG. 242 and a control unit 1001. The control unit 1001 can execute primary deduplication processing as a first stage deduplication processing and secondary deduplication processing as second stage deduplication processing. The control unit 1001 executes the primary deduplication processing on a file regardless of a file format. The control unit 1001 does not execute the secondary deduplication processing when the file format satisfies a predetermined condition but executes the secondary deduplication processing when the file format does not satisfy the predetermined condition. The predetermined condition is such that the file format corresponds to a format defined to have a low deduplication effect, for example, a type of a file defined as any one of a compressed file and a frequently updated file.

More specifically, the control unit 1001 executes only first stage deduplication processing, that is, the primary deduplication processing on a file as a specific file (file satisfying the predetermined condition). In other words, the control unit 1001 divides the specific file into large chunks, and, for each of the large chunks, controls whether to write a comparative target large chunk to the file system 242 based on whether a large chunk duplicated with the comparative target large chunk is stored in the file system 242. Thus, the only non-duplicated large chunks (large chunks including new data portions (non-duplicated file data elements)) in the specific file are written to the file system 242.

The control unit 1001 executes the two stage deduplication processing, that is, both the primary deduplication processing and the secondary deduplication processing on a file as a non-specific file (file that does not satisfy the predetermined condition). More specifically, in the primary deduplication processing, the control unit 1001 divides the non-specific file into large chunks and, for each of the large chunks, determines whether a large chunk duplicated with the large chunk is stored in the file system 242. If the determination result is false, and the large chunk is a large chunk of the non-specific file, the control unit 1001 executes the secondary deduplication processing. In the secondary deduplication processing, the control unit 1001 divides the non-duplicated large chunk into small chunks and determines for each of a plurality of small chunks, whether a small chunk duplicated with a comparative target small chunk is stored in the file system 242. If the determination result is false, the control unit 1001 writes the comparative target small chunk to the file system 242. Thus, only the non-duplicated small chunks (small chunks including new data portions) in the non-specific file are written to the file system 242.

As described above, whether the deduplication processing is executed in a single stage or in two stages can be appropriately controlled for each file. As a result, a high deduplication effect can be obtained while reducing a load for executing the deduplication processing, whereby both reduction of the consumed capacity and the performance improvement of the file system 242 can be achieved.

An overview of the embodiment is as described above.

The multi-stage deduplication processing in the present embodiment is two stage deduplication processing. Alternatively, the deduplication processing may include three or more stages. In other words, tertiary deduplication processing, quaternary deduplication processing, . . . may be executed.

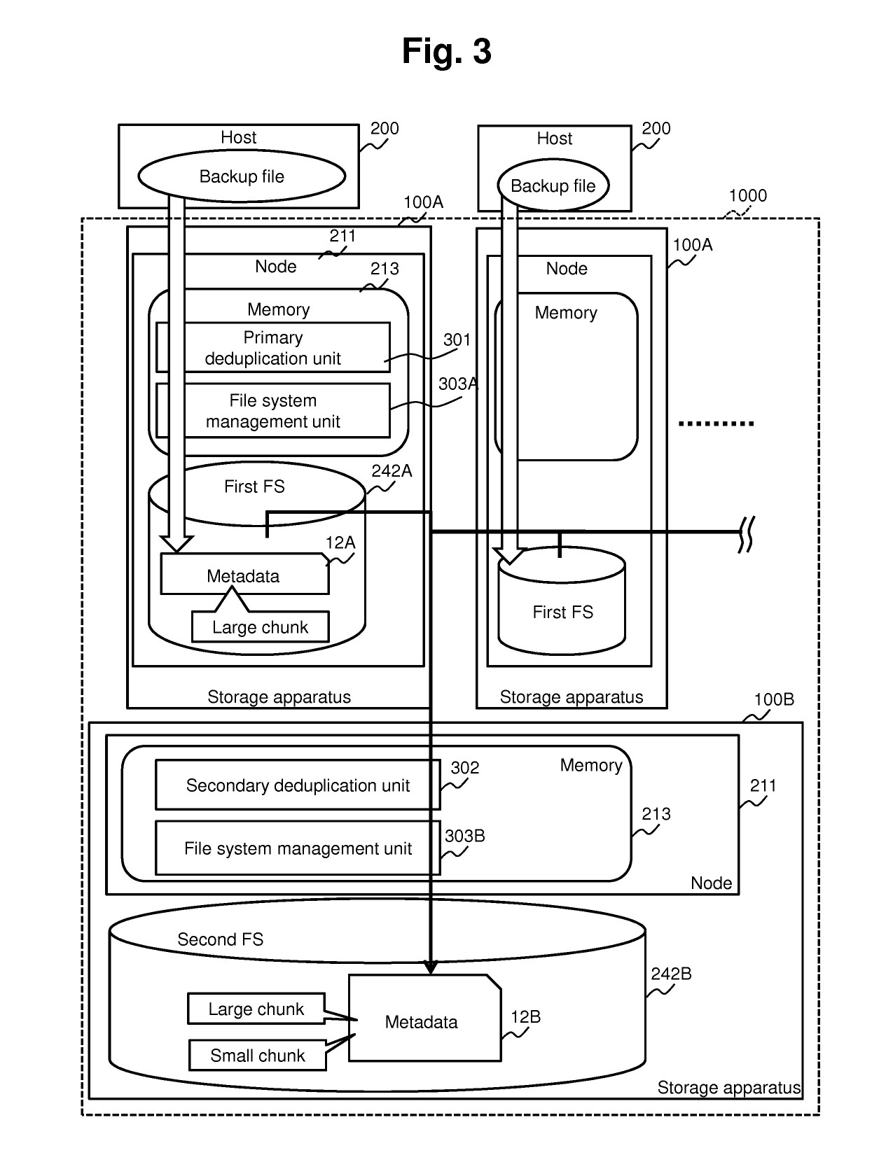

The storage system 1000 may include one or a plurality of storage apparatuses. A storage apparatus with which the primary deduplication processing is executed and a storage apparatus with which the secondary deduplication processing is executed may be the same storage apparatus, or may be different storage apparatuses as exemplary illustrated in FIG. 3. When the primary deduplication processing and the secondary deduplication processing are executed with different storage apparatuses, load balancing can be achieved, and the start timing of the secondary deduplication processing can be controlled in accordance with a load on the storage apparatus with which the secondary deduplication processing is executed.

At least one of the large chunk and the small chunk may be compressed, and the deduplication determination may be performed on the compressed chunk. By thus compressing the chunk, the consumed capacity of the file system 242 can be reduced. The chunk size (length) may be the same (fixed size) or different (variable size) among the large chunks. Similarly, the chunk size (length) may be the same (fixed size) or different (variable size) among the small chunks.

The embodiment is described in detail below. A file in the description below is assumed to be a backup file (a file which is a backup target).

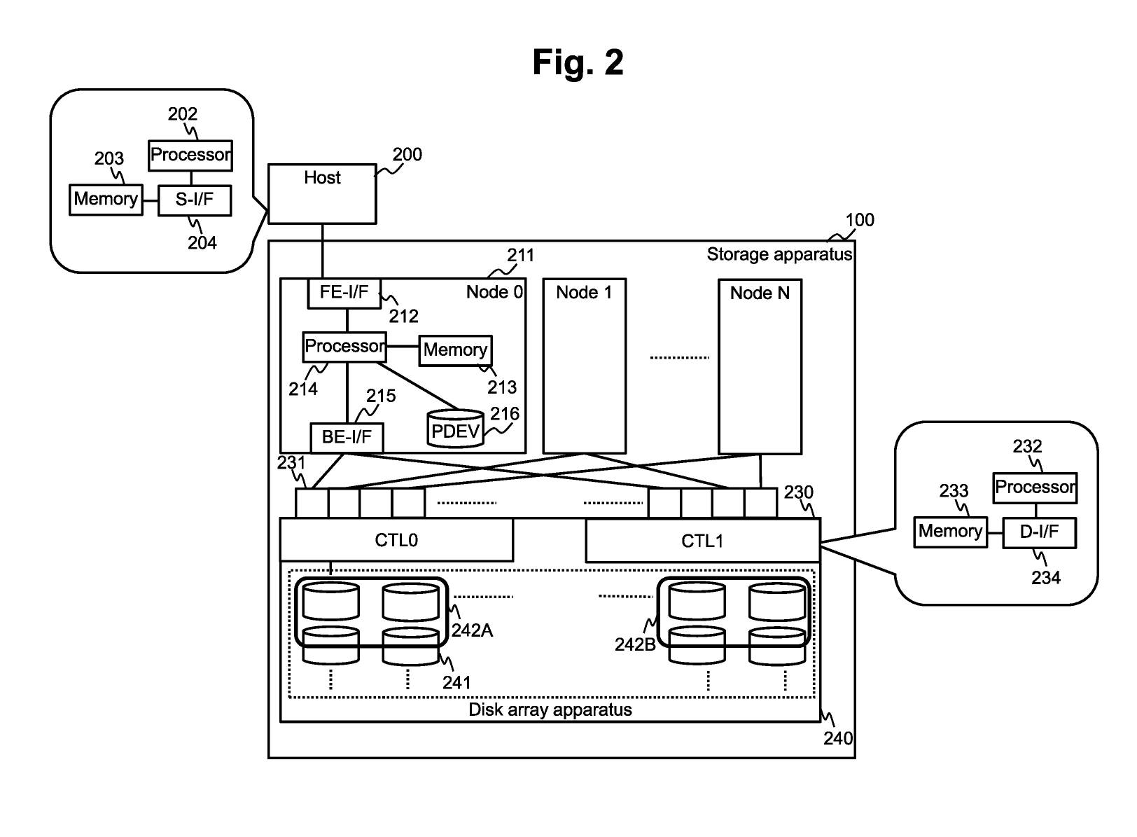

FIG. 2 is a block diagram illustrating a hardware configuration of a system according to the embodiment.

A storage apparatus 100 and a host 200, coupled to the storage apparatus 100 through a communication network (for example, SAN (Storage Area Network)) for example, are provided.

The host 200 is an apparatus that writes and reads a file to and from the storage apparatus 100 by transmitting a write request and a read request for the file. The host 200 is typically a computer but may be other storage apparatuses. The host 200 may include: an interface device (S-I/F) 204 coupled to the storage apparatus 100; a memory 203; and a processor 202 coupled to these components. The S-I/F 204 is an example of an interface unit coupled to the storage apparatus 100. The host 200 may be a virtual machine.

The storage apparatus 100 includes: first and second file systems 242A and 242B; and a storage control unit that executes write processing or read processing for the file in response to the write request or the read request from the host 200. More specifically, the storage apparatus 100 includes one or more nodes 211 and a disk array apparatus 240 coupled to the one or more nodes 211.

The node 211 is an apparatus that converts the write request or read request for the file from the host 200 into a write request or a read request for block data, and transmits the resultant request to the disk array apparatus 240 (or transfers to the disk array apparatus 240, the write request or the read request for the file from the host 200). The node 211 is typically a computer. For example, the node 211 may be a server and the host 200 may be a client. The node 211 includes: a front-end interface device (FE-I/F) 212 coupled to the host 200; a back-end interface device (BE-I/F) 215 coupled to the disk array apparatus 240; a memory 213; and a processor 214 coupled to these components. At least one node 211 may include a PDEV (for example, HDD) 216 coupled to the processor 214.

The disk array apparatus 240 includes: a plurality of PDEVs 241 as bases of a plurality of VOLs; a plurality of ports 231 coupled to the one or more nodes 211; and a controller (“CTL” in the FIG. 230 coupled to the plurality of PDEVs 241. The ports 231 receive the write request or the read request from the node 211. The controller 230 performs reading or writing on the VOL in accordance with the write request or the read request received by the ports 231. The controller 230 may include, in addition to the ports 231: an interface device (D-I/F) 234 coupled to the PDEV 241; a memory 233; and a processor 232 coupled to these components. The controller 230 may have a duplicated structure including a CTL0 and a CTL1. The plurality of VOLs include a VOL as the first file system 242A and a VOL as the second file system 242B.

The storage apparatus 100 may be what is known as a converged storage, and communications in the node 211 and communications between the node 211 and the disk array apparatus 240 may be performed under a PCIe (PCI-Express) protocol. The communications between the node 211 and the disk array apparatus 240 may be performed under a protocol other than PCIe such as FC (Fibre Channel). The BE-I/F 215 may be a host bus adapter and the ports 231 may be FC ports. The storage control unit of the storage apparatus 100 may include one or more nodes 211 or may further include the controller 230. The storage control unit may include: a front-end interface unit coupled to the host 200; and a back-end interface unit coupled to a plurality of PDEVs 241. The front-end interface unit may include one or more FE-I/Fs 212 of one or more nodes 211. The back-end interface unit may include one or more BE-I/Fs 215 of one or more nodes 211 or may include the D-I/F 234 of the controller 230. The node 211 may not be provided, and the disk array apparatus 240 may be coupled to the host 200 with the controller 230 having the functions of the node 211.

FIG. 3 is a block diagram illustrating functions of the storage system according to the embodiment.

The storage system includes a plurality of storage apparatuses 100 including, for example: a plurality of front-end storage apparatuses 100A that receive the write request and the read request for the file from one or more hosts 200; and a back-end storage apparatus 100B coupled to the plurality of storage apparatuses 100A. The first file system 242A is in the storage apparatuses 100A, and the second file system 242B is in the storage apparatus 100B. In other words, the first file system 242A is prepared for each host 200, and the second file system 242B is common among a plurality of first file systems 242A. The first file system 242A is a file system (for example, an online VOL) provided to the host 200, and the second file system 242B is a file system (for example, offline VOL) hidden from the host 200. At least one of the first and the second file systems 242A and 242B may be based on at least one storage resource (for example, a memory) of the node 211 and the controller 230, instead of the PDEVs 241.

The storage system includes a primary deduplication unit 301, a secondary deduplication unit 302, and a file system management unit 303. More specifically, the storage apparatus 100A includes the primary deduplication unit 301 and a file system management unit 303A. The storage apparatus 100B includes the secondary deduplication unit 302 and a file system management unit 303B. The primary deduplication unit 301, the secondary deduplication unit 302 and the file system management unit 303 may be functions respectively implemented when a primary deduplication processing program, a secondary deduplication processing program, and a file system management program are executed by the processor 214 (and/or 232). The primary deduplication unit 301, the secondary deduplication unit 302 and the file system management unit 303 may each be at least partially implemented with dedicated hardware.

The primary deduplication unit 301 executes the primary deduplication processing and the secondary deduplication unit 302 executes the secondary deduplication processing. The file system management unit 303A is an interface for the first file system 242A, and the file system management unit 303B is an interface for the second file system 242B. The primary deduplication unit 301 accesses the first file system 242A through the file system management unit 303A. The secondary deduplication unit 302 accesses the second file system 242B through the file system management unit 303B.

More specifically, the primary deduplication unit 301 receives a backup file (hereinafter, file) from the host 200, executes the primary deduplication processing, and performs the condition determination to determine whether the file is the specific file. In the primary deduplication processing, the primary deduplication unit 301 divides the file into the large chunks, and determines whether large chunks duplicated with the large chunks are stored in the first or the second file system 242A or 242B, based on metadata 12A in the first file system. 242A (and metadata 12B in the second file system 242B). The metadata 12A is an example of management data for the chunks (large chunks) in the first file system 242A. The metadata 12B is an example of management data for the chunks (at least the small chunks among the small chunks and the large chunks) in the second file system 242B. The metadata 12A and the metadata 12B are described in detail later.

If the condition determination result is false, the secondary deduplication processing is not executed on the file. Thus, the primary deduplication unit 301 writes the non-duplicated large chunks in the primary deduplication processing to the metadata 12A in the first file system 242A through the file system management unit 303A.

If the condition determination result is true, the secondary deduplication processing is executed on the file. Thus, the primary deduplication unit 301 transmits the non-duplicated large chunks in the primary deduplication processing to the secondary deduplication unit 302. In the secondary deduplication processing, the secondary deduplication unit 302 divides the non-duplicated large chunks into small chunks, and determines whether small chunks duplicated with the small chunks are stored in the second file system 242B, based on the metadata 12B in the second file system 242B. The secondary deduplication unit 302 writes the small chunks (non-duplicated small chunks) with the false determination result to the metadata 12B in the second file system 242A through the file system management unit 303B.

When the primary deduplication processing is executed on all the large chunks forming the file, a stub file of the file is generated by the primary deduplication unit 301 and stored in the first file system 242A through the file system management unit 303A.

The control unit of the storage system may include the primary deduplication unit 301, the secondary deduplication unit 302, and the file system management unit 303 (303A and 303B). The primary deduplication unit 301 and the secondary deduplication unit 302 may be integrally formed. The primary deduplication unit 301 and the secondary deduplication unit 302 may be in the same storage apparatus 100. The storage system may include only one storage apparatus 100. The control unit of the storage system may include a storage control unit for one or a plurality of storage apparatuses. The storage control unit of the storage apparatus 100A may include the first processing unit 301 and the file system management unit 303A. The storage control unit of the storage apparatus 100B may include the second processing unit 302 and file system management unit 303B.

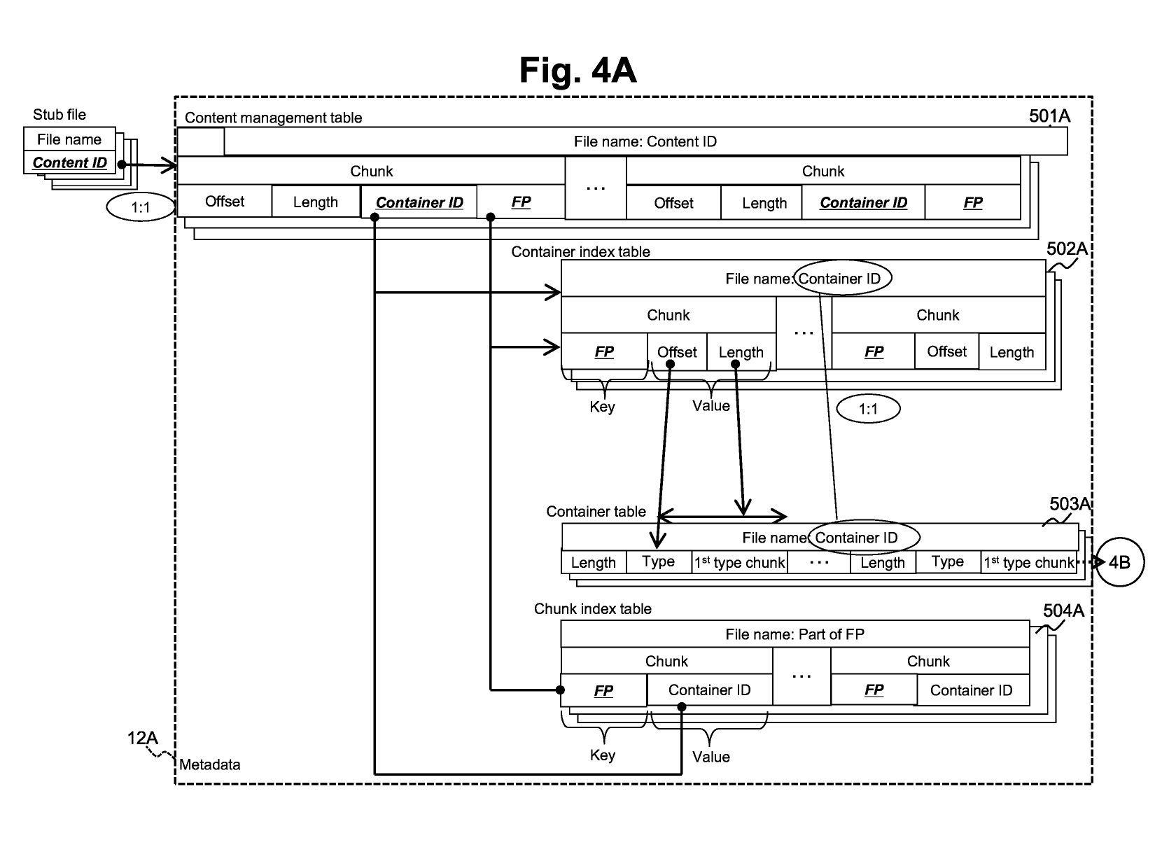

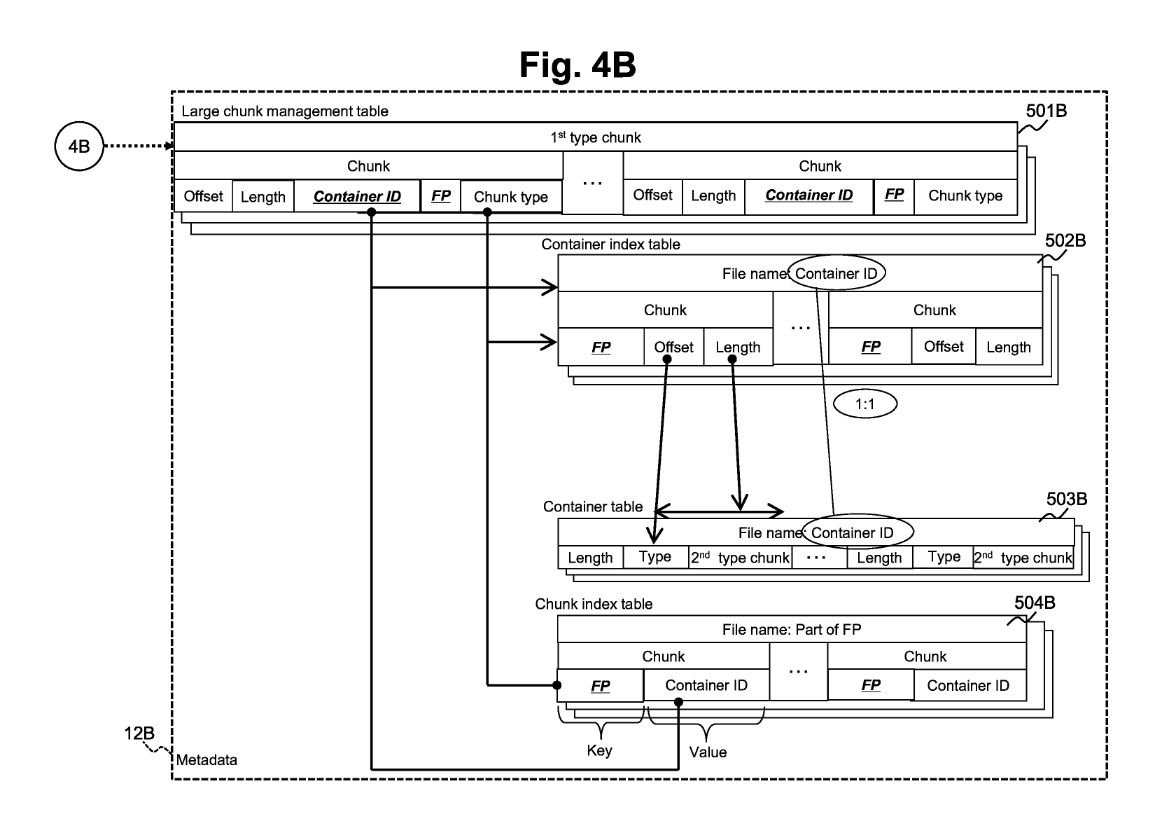

FIG. 4A illustrates a configuration of the metadata 12A.

The metadata 12A may include the non-duplicated large chunks or a pointer to the metadata 12B. By referring to the metadata 12A (and 12B) using the comparative target large chunk, it is possible to determine whether a large chunk duplicated with the comparative target large chunk is in the first or the second file system 242A or 242B.

More specifically, the metadata 12A includes a content management table 501A, a container index table 502A, a container table 503A, and a chunk index table 504A. In the metadata 12A, “content” indicates a file, “chunk” indicates a large chunk or a small chunk, and “container” indicates a set of a plurality of chunks. In the present embodiment, a large container as a set of a plurality of large chunks and a small container as a set of a plurality of small chunks are provided.

The content management table 501A is a table associated with a single stub file. The stub file corresponds to a single file. A content ID is written to the stub file. The content ID is generated as identification information of a file corresponding to the stub file by the primary deduplication unit 301. The content management table 501A includes a content ID, which is the same as the content ID of the stub file corresponding to the table 501A, as a file name of the table 501A for example. The content management table 501A includes, for each of the large chunks forming the file associated with the table 501A: an offset (a difference between a top address of the file and a top address of the large chunk); a length (the size of the large chunk); a container ID (an ID for a large container); and a fingerprint (a hash value of the large chunk (“FP” in the figure)). The fingerprint is an example of data indicating the characteristics of the large chunk.

The container index table 502A is provided for each large container. The container index table 502A includes the container ID, which is the identification information of the large container corresponding to the table 502A, as a file name of the table 502A for example. The container index table 502A includes, for each of the large chunks forming the large container corresponding to the table 502A:

a fingerprint (the fingerprint of the large chunk); an offset (a difference between the top address of the container table 503A corresponding to the table 502A and the top address of the chunk data); and a length (the length of the chunk data).

The container table 503A is provided for each large container. Thus, the container index table 502A corresponds to a single container table 503A. The container table 503A includes a container ID, which is identification information of the large container corresponding to the table 503A, as a file name of the table 503A for example. The container table 503A includes, for each of the large chunks forming the large container corresponding to the table 503A: a length (the size of the chunk data); and a type (the type of the large chunk); a first type chunk (the large chunk as it is or a pointer (for example, the ID of the first type chunk) to the metadata 12B). The type of the large chunk is a file format (for example, an extension of the file) including the large chunk for example. The length (the size of the chunk data) may not be included.

The chunk index table 504A includes, for each of a predetermined number of large chunks: a fingerprint (the fingerprint of a large chunk); and a container ID (the container ID of the large container including the large chunk). The chunk index table 504A includes apart of at least one fingerprint (for example, the top fingerprint) in the table 504A as a file name for example.

FIG. 4B illustrates a configuration of the metadata 12B.

The metadata 12B may include the non-duplicated large chunks and the non-duplicated small chunks. By referring to the metadata 12B through the metadata 12A using the comparative target chunk (the large chunk or the small chunk), it is possible to determine whether a chunk duplicated with the comparative target chunk is in the second file system 242B.

The metadata 12B has substantially the same configuration as the metadata 12A when the content (file) of the metadata 12A is replaced with the large chunk. More specifically, the metadata 12B includes a large chunk management table 501B; a container index table 502B; a container table 503B; and a chunk index table 504B.

The large chunk management table 501B includes an ID, which is the same as the ID of the large chunk associated with the table 501B, as a file name of the table 501B. The large chunk management table 501B includes, for each of the small chunks forming the large chunk corresponding to the table 501B: an offset (a difference between the top address of the large chunk and the top address of the small chunk); a length (the size of the small chunk); a container ID (an ID of the small container); and a fingerprint (a hash value of the small chunk). The large chunk, simply migrated from the first file system 242A to the second file system 242B, is not divided into the small chunks, and thus the large chunk management table 501B corresponding to such a large chunk may include the large chunk as it is.

The container index table 502B is provided for each small container. The container index table 502B includes a container ID, which is identification information of the small container corresponding to the table 502B, as a file name of the table 502B for example. The container index table 502B includes, for each of the small chunks forming the small container corresponding to the table 502B: a fingerprint (a fingerprint of the small chunk); an offset (a difference between the top address of the container table 503B corresponding to the table 502B and the top address of the chunk data); and a length (a length of the chunk data).

The container table 503B is provided for each small container. Thus, the container index tables 502B respectively correspond to the container tables 503B. The container index table 503B includes a container ID, which is identification information of the small container corresponding to the table 503B, as a file name of the table 503B for example. The container table 503B includes, for each of the small chunks forming the small container corresponding to the table 503B: a length (the size of the chunk data); a type (the type of the small chunk); and a second type chunk (the small chunk as it is). The type of the small chunk is a file format (for example, an extension of the file) including the small chunk for example. The length (the size of the chunk data) may not be included.

The chunk index table 504B include, for each of a predetermined number of small chunks: a fingerprint (the fingerprint of the small chunk); and a container ID (a container ID of the small container including the small chunk). The chunk index table 504B includes, for example, apart of at least one fingerprint (for example, the top fingerprint) in the table 504B, as a file name.

Methods of using and updating the metadata 12A and the metadata 12B will be described later. The writing or the reading to or from at least one of the first and the second file systems 242A and 242B (alternatively, a PDEV on which at least one of the first and the second file systems 242A and 242B is based) may be performed in a unit of a chunk (large chunk, small chunk), or a unit of a container (unit of a large container or a unit of a small container) including a plurality of chunks. For example, the writing or the reading is performed in a unit of a container, when the size of a unit of the writing or the reading to or from the PDEV is larger than the size of the chunk and the size of the container is a multiple of the unit size of the writing or the reading to or from the PDEV. When the deduplication processing includes three or more stages, metadata such as the metadata 12B is associated in series with the metadata 12B.

The storage system can execute synchronous processing, first asynchronous processing, and second asynchronous processing. An overview of each processing is described below.

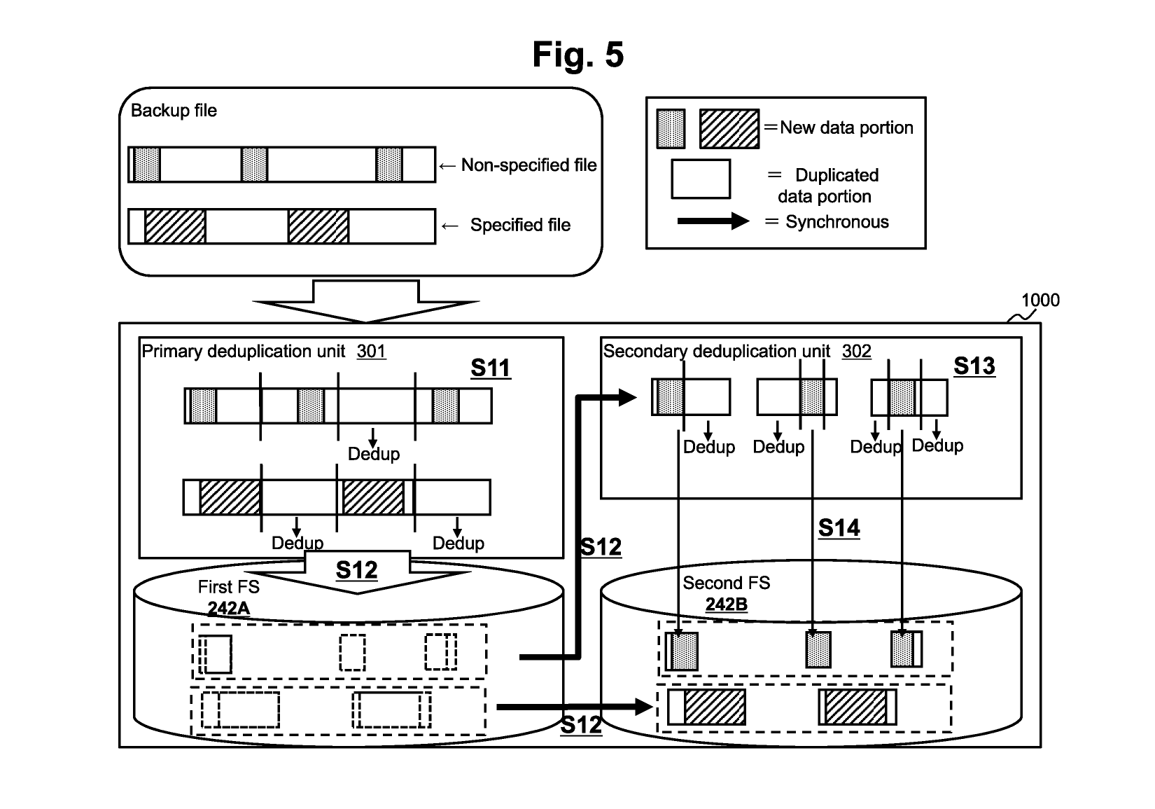

FIG. 5 illustrates an overview of the synchronous processing.

The synchronous processing is processing executed while the write processing for a file is in process. When the synchronous processing is terminated, the write processing for the file is terminated, and the primary deduplication unit 301 notifies the host 200 that has issued the write request for the file, of the termination of the writing. More specifically, for example, the processing is executed as follows. In FIG. 5, dotted line blocks in the first file system 242A indicate that no data is written to the first file system 242A.

(S11) In the primary deduplication processing, the primary deduplication unit 301 divides a file into large chunks.
(S12) The primary deduplication unit 301 determines whether a duplicated large chunk is stored in the first or the second file system 242A or 242B for each large chunk. When the non-duplicated large chunk is a large chunk in the specific file (for example, a compressed file), the primary deduplication unit 301 writes the non-duplicated large chunk to the second file system 242B. When the non-duplicated large chunk is a large chunk in the non-specific file (a file other than the specific file (for example, an uncompressed file)), the primary deduplication unit 301 transmits the non-duplicated large chunk to the secondary deduplication unit 302.
(S13) The secondary deduplication unit 302 executes the secondary deduplication processing on the non-duplicated large chunk. In the secondary deduplication processing, the secondary deduplication unit 302 divides the large chunk into small chunks.
(S14) In the secondary deduplication processing, the secondary deduplication unit 302 determines whether a duplicated small chunk is stored in the second file system 242B, for each small chunk. The secondary deduplication unit 302 writes the non-duplicated small chunk to the metadata 12B in the second file system 242B.

In S12, the primary deduplication unit 301 updates the metadata 12A. For example, the primary deduplication unit 301 writes information related to the duplicated large chunk to the metadata 12A. For example, the primary deduplication unit 301 writes the information related to the non-duplicated large chunk, transmitted to the secondary deduplication unit 302, to the metadata 12A. Similarly, in S14, the secondary deduplication unit 302 updates the metadata 12B. For example, the secondary deduplication unit 302 writes information related to the duplicated small chunk to the metadata 12B.

A write destination designated by the write request from the host 200, is the first file system 242A as a file system provided to the host 200. In the synchronous processing, neither the large chunk nor the small chunk in the file is written to the first file system 242A.

In the synchronous processing, the large chunk is not written to the first file system 242A, and thus the first file system 242A may have a required storage capacity smaller than that in the first asynchronous processing and the second asynchronous processing.

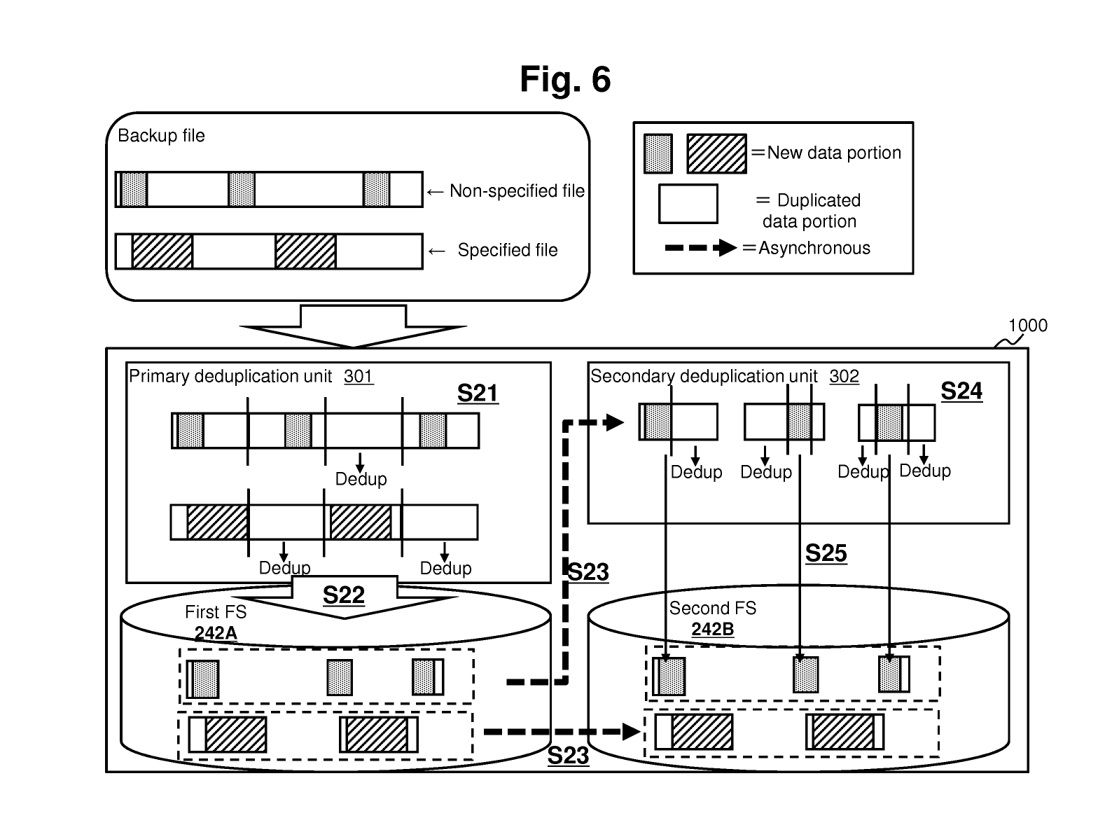

FIG. 6 illustrates an overview of the first asynchronous processing.

In the first asynchronous processing, the primary deduplication unit 301 temporarily writes non-duplicated large chunks, among the large chunks as a result of the dividing, to the first file system 242A in the write processing for a file, regardless of the file format. Then, the primary deduplication unit 301 transmits (migrates) the non-duplicated large chunks from the first file system 242A to the secondary deduplication unit 302 or the second file system 242B, asynchronously with the write processing for the file. More specifically, for example, the processing is executed as follows (description on points that are the same as those in the synchronous processing will be omitted or simplified).

(S21) The primary deduplication unit 301 divides a file into large chunks in the primary deduplication processing, while the write processing for the file is in process.
(S22) The primary deduplication unit 301 determines whether a duplicated large chunk is stored in the first or the second file system 242A or 242B for each large chunk, while the write processing for the file is in process. The primary deduplication unit 301 writes the non-duplicated large chunks and information related to the large chunks to the metadata 12A in the first file system 242A.
(S23) The primary deduplication unit 301 executes migration processing asynchronously with the write processing for the file. In the migration processing, when the large chunk (non-duplicated large chunk) in the first file system is the large chunk in the specific file, the primary deduplication unit 301 migrates the large chunk to the second file system 242B. When the large chunk is a large chunk in the non-specific file, the primary deduplication unit 301 transmits the large chunk to the secondary deduplication unit 302.

In the migration processing, the non-duplicated large chunk transmitted to the secondary deduplication unit 302 is subjected to the processing that is similar to those in S13 and S14 in FIG. 5 (S24 and S25).

In the first asynchronous processing, the write processing for the file is terminated when the processing in S22 is completed on all the large chunks forming the file. Thus, a backup window (the time required for the backup processing) for the host 200 is shorter than that in the synchronous processing.

In the first asynchronous processing, the primary deduplication unit 301 may temporarily write the file, received from the host 200, to the first file system 242A (so that the write processing for the file is terminated), may perform primary deduplication on the file in the first file system 242A asynchronously with the write processing for the file, and may control whether the non-duplicated large chunk is transmitted to the secondary deduplication unit 302 or written to the second file system 242B, depending on whether the file is the specific file or the non-specific file. Thus, an even shorter write processing time can be achieved.

In the first asynchronous processing, the migration processing (transmission of the large chunk from the first file system 242A to the secondary deduplication unit 302 or the second file system 242B) is executed asynchronously with the write processing for the file. Alternatively, the migration processing may be periodically started, or started when a predetermined start condition is satisfied. The predetermined start condition may be satisfied when a free capacity of the first file system 242A drops below a predetermined capacity, or when a load (for example, a processor usage rate) of at least one of the processor that executes the primary deduplication unit 301 and the processor that executes the secondary deduplication unit 302 drops below a predetermined load. The migration processing may be terminated when at least one large chunk in the first file system 242A is migrated, or when a predetermined end condition is satisfied. The predetermined end condition may be satisfied when the free capacity of the first file system 242A becomes equal to or larger than the predetermined capacity, or when the load of at least one of the processor that executes the primary deduplication unit 301 and the processor that executes the secondary deduplication unit 302 becomes equal to or larger than the predetermined load. The free capacity of the first file system 242A may be equivalent to a free capacity ratio of the first file system 242A. The free capacity ratio of the first file system 242A is a ratio of the free capacity of the first file system 242A to the capacity of the first file system 242A.

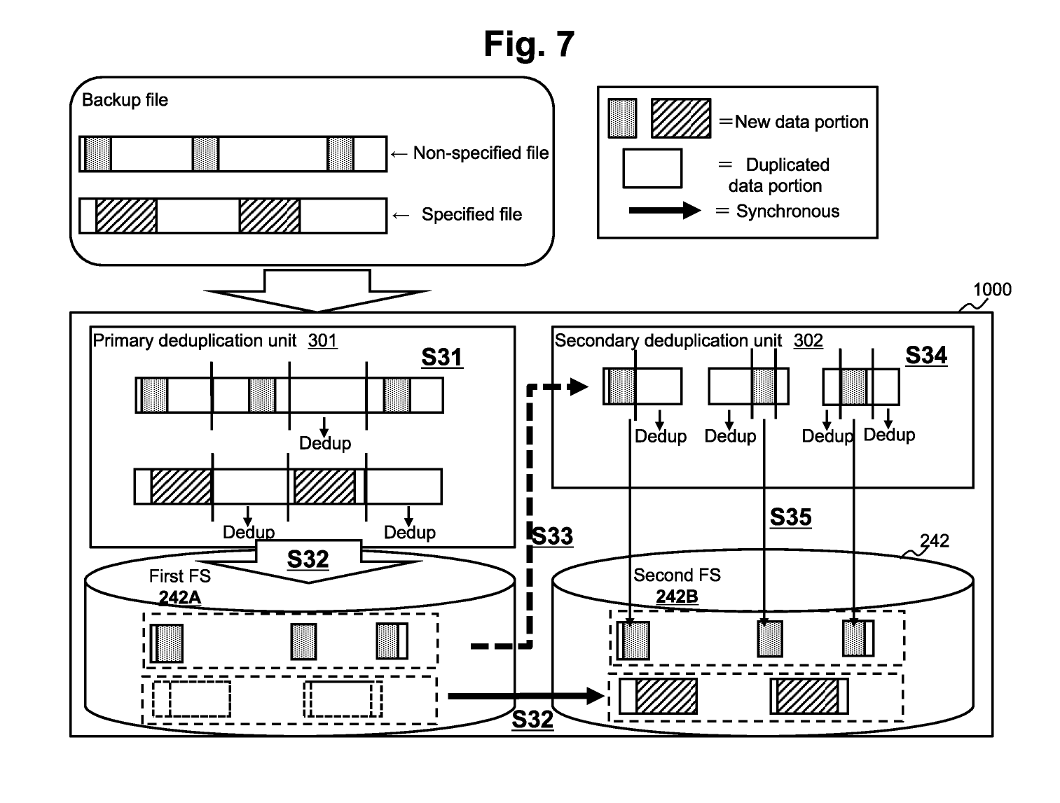

FIG. 7 illustrates an overview of the second asynchronous processing.

In the second asynchronous processing, the primary deduplication unit 301 writes, in the write processing for a file, a non-duplicated large chunk to the first file system 242A when the file is the non-specific file. On the other hand, unlike in the first asynchronous processing, the primary deduplication unit 301 writes the non-duplicated large chunk to the second file system 242B when the file is the specific file. The processing thereafter is the same as or similar to that in the first asynchronous processing. More specifically, for example, the second asynchronous processing is executed as follows (description on points that are the same as those in the first asynchronous processing will be omitted or simplified). In FIG. 7, dotted line blocks in the first file system 242A indicate that no data is written to the first file system 242A.

(S31) The primary deduplication unit 301 divides a file into large chunks in the primary deduplication processing, while the write processing for the file is in process.
(S32) The primary deduplication unit 301 determines whether a duplicated large chunk is stored in the first or the second file system 242A or 242B for each large chunk, while the write processing for the file is in process. When the file including the non-duplicated large chunk is the non-specific file, the primary deduplication unit 301 writes the non-duplicated large chunk and information related to the large chunk to the metadata 12A in the first file system 242A. When the file including the non-duplicated large chunk is the specific file, the primary deduplication unit 301 writes the non-duplicated large chunk and information related to the large chunk to the metadata 12B in the second file system 242B (and also updates the metadata 12A).
(S33) The primary deduplication unit 301 executes migration processing asynchronously with the write processing for the file. In the migration processing, the primary deduplication unit 301 transmits the large chunks (non-duplicated large chunks) in the first file system to the secondary deduplication unit 302.

The non-duplicated large chunks transmitted to the secondary deduplication unit 302 are subjected to the processing that is similar to those in S13 and S14 in FIG. 5 (S34 and S35).

According to the second asynchronous processing, the large chunk in the non-specific file (for example, an uncompressed file) is the only chunk written to the first file system 242A. Thus, the migration processing (transmission of the large chunk from the first file system 242A to the secondary deduplication unit 302) can be performed in a shorter period of time.

As described above, the storage system can execute any of the synchronous processing, the first asynchronous processing, and the second asynchronous processing. For example, the first to the third storage apparatuses 100A in the plurality of front-end storage apparatuses 100A illustrated in FIG. 3 may respectively execute the synchronous processing, the first asynchronous processing, and the second asynchronous processing. Alternatively, each of the storage apparatuses 100A may be capable of executing the synchronous processing, the first asynchronous processing, and the second asynchronous processing, and may selectively execute any one of the synchronous processing, the first asynchronous processing, and the second asynchronous processing. Which one of the synchronous processing, the first asynchronous processing, and the second asynchronous processing is to be executed may be determined for each storage system, each storage apparatus, each host, each application, and/or each file.

In the present embodiment, the single stage deduplication processing is executed on (the secondary deduplication processing is not executed on) the file as the specific file, and the two stage deduplication processing is executed on the file as the non-specific file. The specific file is a file of a format defined to be compressed or to have a high update frequency. More specifically, for example, the specific file may be any one of a compressed file (for example, a file with an extension “gzip”, “bzip2”, “zip” or “cab”), an image file (for example, a file with an extension “jpeg”, “png”, “gif” or “pdf”), a log file (for example, a file with an extension “log”), and a dump file (for example, a file with an extension “dmp”). The non-specific file may be a file other than the specific file, that is, for example, a file with an extension “tar”, “cpio”, “vhd”, “vmdk”, “vdi”, or the like.

Processing executed in the present embodiment is described in detail below.

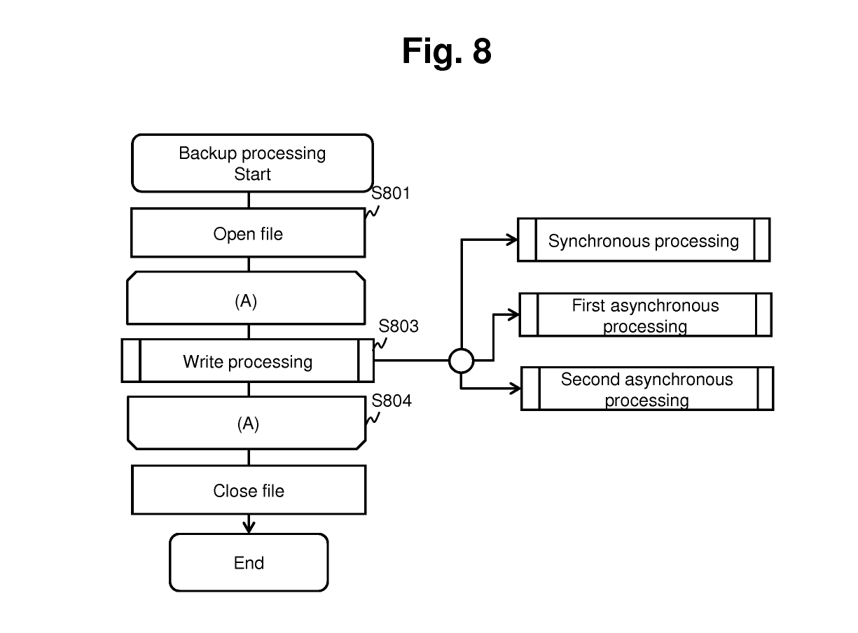

FIG. 8 illustrates a flow of backup processing.

A file is opened (S801). Write processing is executed on the file (S803) for a number of times corresponding to the size (loop (A)) of the file, and then the file is closed (S805). In S805, the storage apparatus 100A notifies the host 200 of the write completion. In the write processing for the file (S803), any one of the synchronous processing, the first asynchronous processing, and the second asynchronous processing is executed.

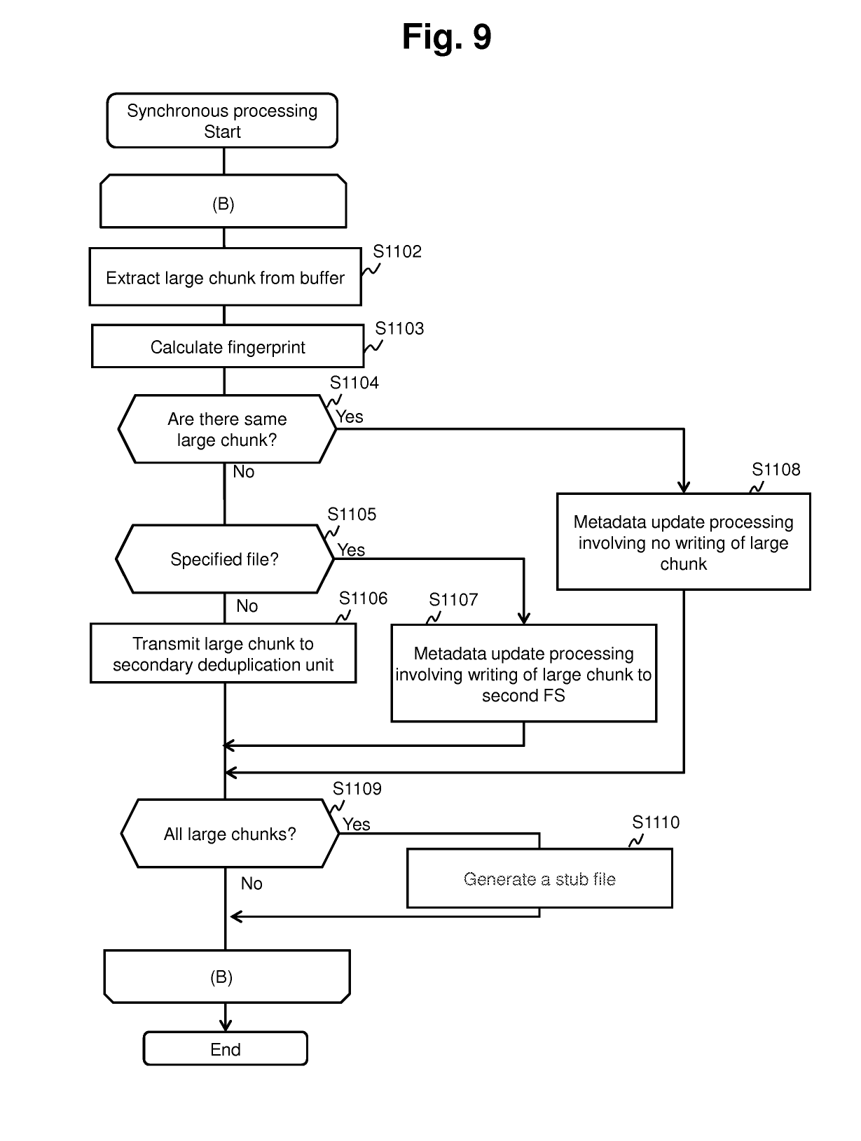

FIG. 9 illustrates a flow of the synchronous processing.

A write target file received by the storage apparatus 100A is stored for example, in a buffer provided in the memory 213 of the node 211. S1102 to S1111 are executed for the number of times corresponding to a predetermined size (loop (B)). The predetermined size may be equal to or less than a buffer size.

The primary deduplication unit 301 extracts a single large chunk from the file in the buffer (S1102), and calculates a fingerprint of the extracted large chunk (S1103). In the description with reference to FIG. 9, the large chunk extracted in S1102 is referred to as a “target large chunk”, a file including the target large chunk is referred to as a “target file”, and the fingerprint calculated in S1103 is referred to as a “target fingerprint”.

The primary deduplication unit 301 determines whether a large chunk duplicated with the target large chunk is in the first or the second file system 242A or 242B (S1104). More specifically, the primary deduplication unit 301 searches the metadata 12A with the target fingerprint as a key. The determination result in S1104 is true (same large chunk found) when the fingerprint matching the target fingerprint is found, and otherwise, the determination result in S1104 is false (no same large chunk).

If the determination result is true in S1104 (S1104: Yes), the primary deduplication unit 301 executes metadata update processing involving no writing of the target large chunk (S1108). More specifically, for example, the primary deduplication unit 301 (1) identifies a target container ID (a container ID associated with the found fingerprint in the table 504A), and (2) writes the target fingerprint, the target container ID, a target offset (an offset of the target large chunk in the target file), and a target length (a size of the target large chunk) to the content management table 501A corresponding to the target file.

If the determination result is false in S1104 (S1104: No), the primary deduplication unit 301 determines whether the target file is the specific file (S1105). When the target file is the non-specific file (S1105: No), the primary deduplication unit 301 transmits the target large chunk to the secondary deduplication unit 302 (S1106). When the target file is the specific file (S1105: Yes), the primary deduplication unit 301 executes the metadata update processing involving the writing of the target large chunk to the second file system 242B (S1107). More specifically, for example, the primary deduplication unit 301 (1) writes the target large chunk to the metadata 12B, as the large chunk management table 501B, (2) writes a target first type chunk (a pointer to the table 501B written in (1) described above), a target length (a length of the pointer) and a target type (a target file format) to a free field in the container table 503A, (3) writes the target fingerprint, a target container ID (a container ID of the write destination table 503A of the pointer of the target large chunk), the target offset (the offset of the target large chunk in the target file), and the target length (the size of the target large chunk) to the content management table 501A corresponding to the target file, (4) writes the target fingerprint, a target offset (an offset indicating a position of the target large chunk in the table 503A with the target container ID), and a target length (a size of the pointer of the target large chunk) to the container index table 502A with the target container ID, and (5) writes a pair of the target fingerprint and the target container ID to a free field in the chunk index table 504A.

The first processing unit 301 determines whether the deduplication processing has been completed on all the large chunks forming the target file, based on the content management table 501 corresponding to the target file (S1109). If the determination result is true in S1109 (S1109: Yes), the first processing unit 301 generates a stub file of the target file and writes the content ID to the stub file, and then writes the content ID to the content management table 501A corresponding to the target file (S1110). Also in the synchronous processing, the stub file may be written to the first file system 242A or may be written to the second file system 242B instead of the first file system 242A.

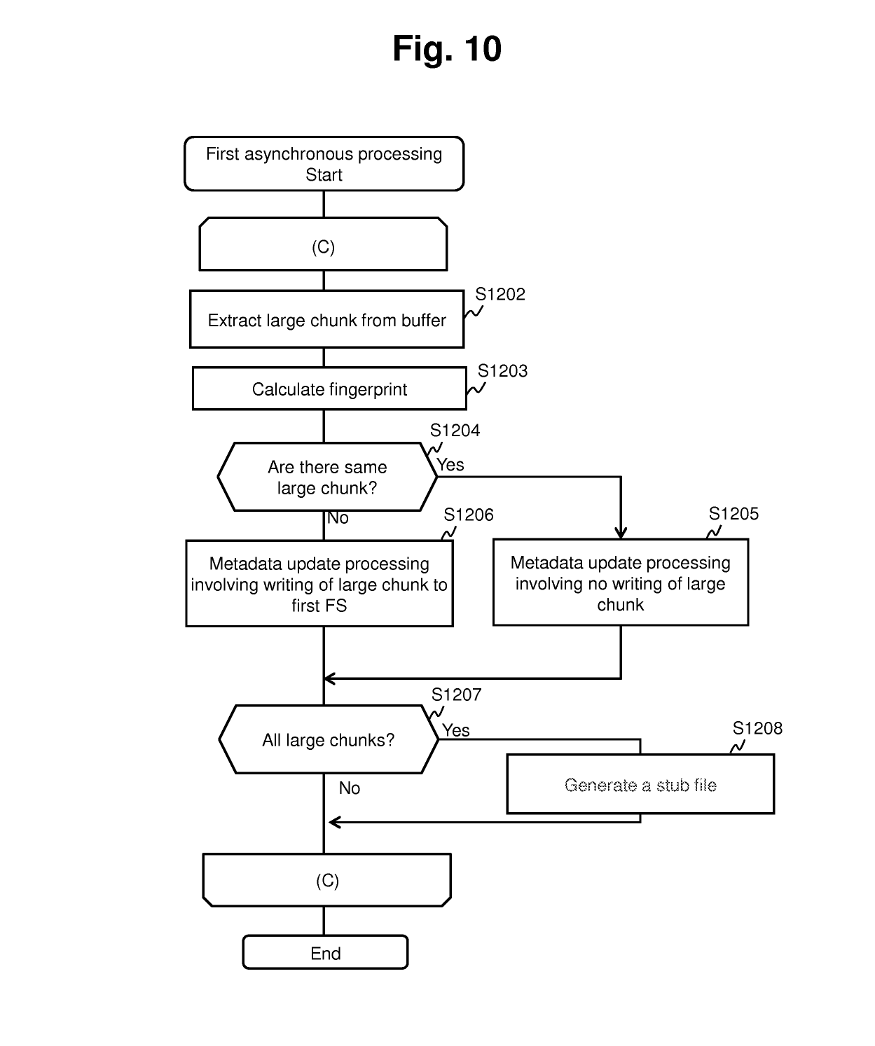

FIG. 10 illustrates a flow of the first asynchronous processing. In the description below, the description on the points that are the same as the synchronous processing is omitted or simplified.

S1202 to S1208 are executed for the number of times corresponding to a predetermined size (loop (C)).

The processing that is the same as that in S1102 to S1104 in FIG. 9 is executed (S1202 to S1204).

If the determination result is true in S1204 (S1204: Yes), the primary deduplication unit 301 executes the metadata update processing involving no writing of the target large chunk (S1205). This processing is similar to or the same as the processing in S1108 in FIG. 9.

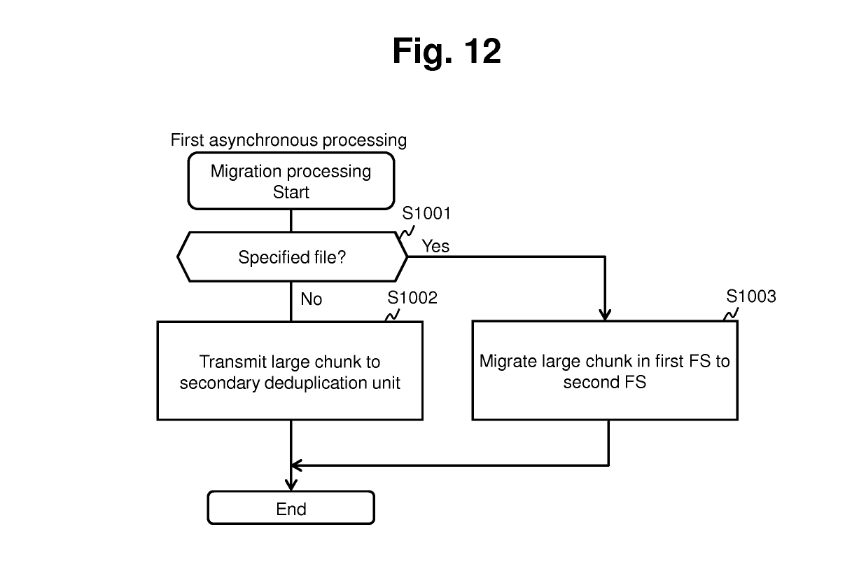

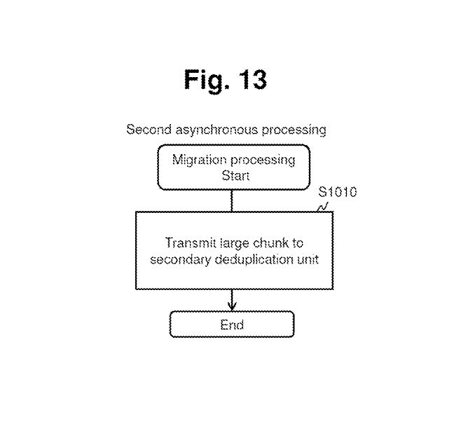

If the determination result is false in S1204 (S1204: No), the primary deduplication unit 301 executes the metadata update processing involving the writing of the target large chunk to the first file system 242A (S1206). More specifically, for example, the primary deduplication unit 301 (1) writes the target first type chunk (target large chunk), the target length (the size of the target large chunk), and the target type (target file format) to a free field in the container table 503A, (2) writes the target fingerprint, the target container ID (the container ID of the write destination table 503A of the target large chunk), the target offset (the offset of the target large chunk in the target file), and the target length (the size of the target large chunk) to the content management table 501A corresponding to the target file, (3) writes the target fingerprint, the target offset (the offset indicating the position of the target large chunk in the table 503A with the target container ID), and the target length (the size of the target large chunk) to the container index table 502A with the target container ID, and (4) writes the pair of the target fingerprint and the target container ID to a free field in the chunk index table 504A. In S1206, the no updating of the metadata 12B in the second file system 242B is performed. In S1206, the target type in (1) described above may include information indicating which one of the first asynchronous processing and the second asynchronous processing has been executed. Thus, the primary deduplication unit 301 determines which one of the migration processing in FIG. 12 and the migration processing in FIG. 13 is to be executed on the large chunk corresponding to the target type by referring to the target type, and can execute the migration processing corresponding to the determination result.

Processing that is similar to or the same as the processing in S1109 and S1110 in FIG. 9 is executed after S1205 or S1206 (S1207 and S1208).

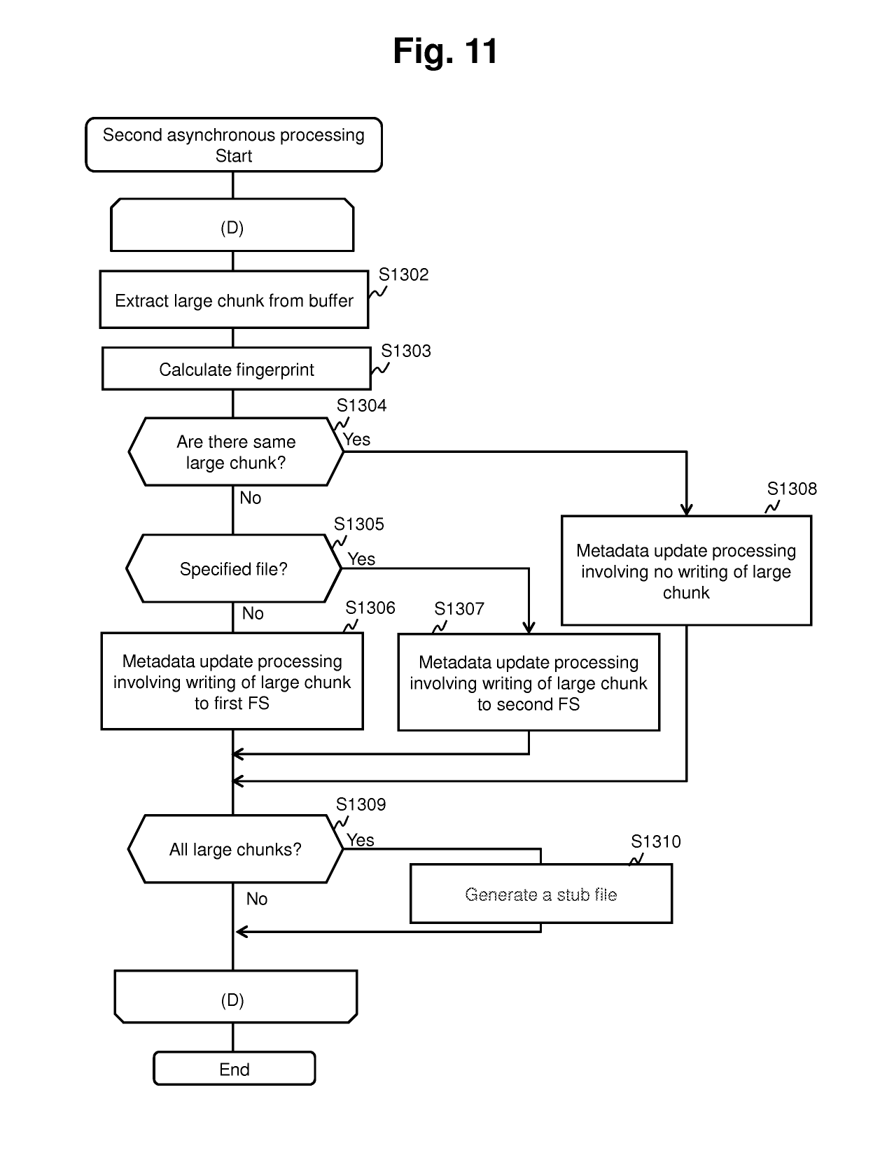

FIG. 11 illustrates a flow of the second asynchronous processing. In the description below, the description on the points that are the same as the synchronous processing and the first asynchronous processing is omitted or simplified.

S1302 to S1308 are executed for the number of times corresponding to a predetermined size (loop (D)).

The processing that is the same as that in S1102 to S1104 in FIG. 9 is executed (S1302 to S1304).

If the determination result is true in S1304 (S1304: Yes), the primary deduplication unit 301 executes the metadata update processing involving no writing of the target large chunk (S1305). This processing is similar to or the same as the processing in S1108 in FIG. 9.

If the determination result is false in S1304 (S1304: No), the primary deduplication unit 301 executes the metadata update processing involving the writing of the target large chunk to the first file system 242A (S1306) when the target file is the non-specific file (S1305: No), and executes the metadata update processing involving the writing of the target large chunk to the second file system 242B (S1307) when the target file is the specific file (S1305: Yes). S1306 is processing that is similar to or the same as the processing in S1206 in FIG. 10, and S1307 is processing that is similar to or the same as the processing in S1107 in FIG. 9.

Processing that is similar to or the same as the processing in S1109 and S1110 in FIG. 9 is executed after S1306 or S1307 (S1309 and S1310).

FIG. 12 illustrates a flow of migration processing corresponding to the first asynchronous processing.

The primary deduplication unit 301 refers to the type corresponding to the large chunk as a migration target in the container table 503A in the metadata 12A, and determines whether a file including the large chunk as the migration target is the specific file, based on the type (S1001).

If the determination result is false in S1001 (S1001: No), the primary deduplication unit 301 transmits the large chunk as the migration target to the secondary deduplication unit 302 (S1002). In S1002, the primary deduplication unit 301 may update the metadata 12A and 12B. More specifically, for example, the primary deduplication unit 301 (1) writes the large chunk management table 501B corresponding to the large chunk as the migration target to the metadata 12B, and (2) changes the large chunk (first type chunk) as the migration target in the container table 503A to the pointer to the table 501B written in (1) described above.

If the determination result is true in S1001 (S1001: Yes), the primary deduplication unit 301 migrates the large chunk as the migration target to the second file system 242B (S1003). Thus, in S1003, the primary deduplication unit 301 updates the metadata 12A and 12B. More specifically, for example, the primary deduplication unit 301 (1) writes (copies) the large chunk as the migration target to the metadata 12B, as the large chunk management table 501B, and (2) changes the large chunk (first type chunk) as the migration target in the container table 503A to the pointer to the table 501B written in (1) described above.

FIG. 13 illustrates a flow of migration processing corresponding to the second asynchronous processing.

The primary deduplication unit 301 transmits a large chunk as the migration target in the container table 503A in the metadata 12A to the secondary deduplication unit 302 (S1010). The processing in S1010 may be the same as the processing in S1002 in FIG. 12.

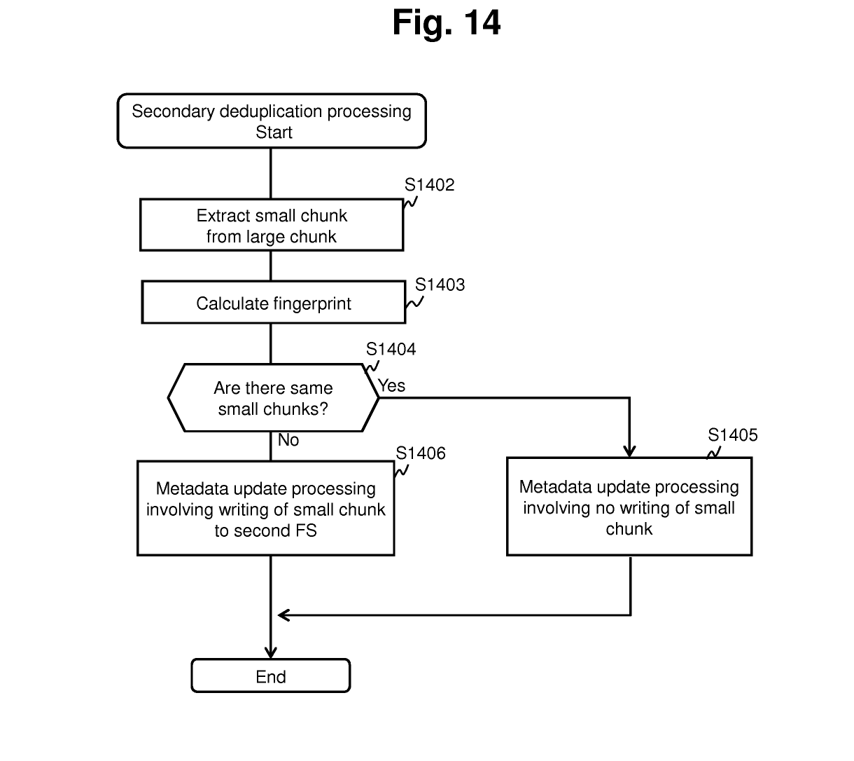

FIG. 14 illustrates a flow of the secondary deduplication processing executed by the secondary deduplication unit 302 that has received the large chunk. The secondary deduplication processing may be executed during the synchronous processing in the write processing for the file (S1106 in FIG. 9), or may be executed during the migration processing that is asynchronously executed with respect to the write processing for the file (S1102 in FIG. 12 and S1010 in FIG. 13).

The secondary deduplication unit 302 extracts a small chunk from the received large chunk (S1402), and calculates the fingerprint of the extracted small chunk (S1403). In the description below with reference to FIG. 14, the small chunk extracted in S1402 is referred to as a “target small chunk”, the large chunk including the target small chunk is referred to as a “target large chunk”, the file including the target small chunk is referred to as a “target file”, and the fingerprint calculated in S1403 is referred to as a “target fingerprint”.

The secondary deduplication unit 302 determines whether a small chunk duplicated with the target small chunk is in the second file system 242B (S1404). More specifically, the secondary deduplication unit 302 searches the metadata 12B with the target fingerprint as a key. The determination result in S1404 is true (same small chunk found) when the fingerprint matching the target fingerprint is found, and otherwise, the determination result in S1404 is false (no same small chunk).

If the determination result is true in S1404 (S1404: Yes), the secondary deduplication unit 302 executes the metadata update processing involving no writing of the target small chunk (S1405). More specifically, for example, the secondary deduplication unit 302 (1) identifies a target container ID (a container ID associated with the found fingerprint in the table 504B), and (2) writes the target fingerprint, the target container ID, a target offset (an offset of the target small chunk in the target large chunk), and a target length (a size of the target small chunk) to the large chunk management table 501B corresponding to the target large chunk.

If the determination result is false in S1404 (S1404: No), the secondary deduplication unit 302 executes the metadata update processing involving the writing of the target small chunk to the second file system 242B (S1406). More specifically, for example, the secondary deduplication unit 302 (1) writes a target second type chunk (target small chunk), the target length (the size of the target small chunk), and the target type (target file format (that may be a copy of the type corresponding to the target large chunk)) to a free field in the container table 503B, (2) writes the target fingerprint, a target container ID (a container ID of the write destination table 503B of the target small chunk), the target offset (the offset of the target small chunk in the target large chunk), and the target length (the size of the target small chunk) to the large chunk management table 501B corresponding to the target large chunk, (3) writes the target fingerprint, a target offset (an offset indicating the position of the target small chunk in the table 503A with the target container ID), and a target length (a size of the pointer of the target small chunk) to the container index table 502B with the target container ID, and (4) writes the pair of the target fingerprint and the target container ID to a free field in the chunk index table 504B.

In the present embodiment, read processing for a stub file is executed in the following manner for example. The read processing starts when the storage apparatus 100A receives a read request for a file from the host 200.

The file system management unit 303 restores a file corresponding to the stub file in the following manner. The file system management unit 303 identifies the content management table 501A with a content ID corresponding to the content ID in the stub file. The file system management unit 303 refers to the identified content management table 501A, and executes the following processing (1) to (6) for each large chunk. Specifically, the file system management unit 303 (1) acquires a container ID and a fingerprint corresponding to the large chunk from the specified table 501A, (2) identifies an offset and a length from the container index table 502A including the container ID and the fingerprint thus acquired, (3) loads onto the memory 213, data in a range, in the container table 503A including the container ID acquired in (1) described above, corresponding to the length identified in (2) described above from the position of the offset identified in (2) described above, (4) when the data loaded in (3) described above is a large chunk, keeps the large chunk in the memory 213, (5) when the data loaded in (3) described above is a pointer to the large chunk management table 501B and the table 501B is the large chunk as it is, loads the large chunk onto the memory 213, and (6) when the data loaded in (3) described above, is the pointer to the large chunk management table 501B and the table 501B is a table that manages a plurality of small chunks, executes the following processing (11) to (13) on each small chunk. Specifically, the file system management unit 303 (11) acquires a container ID and a fingerprint corresponding to the small chunk from the table 501B, (12) identifies an offset and a length from the container index table 502B including the container ID and the fingerprint thus acquired, and (13) loads onto the memory 213, data in a range, in the container table 503B including the container ID acquired in (11) described above, corresponding to the length identified in (12) described above from the position of the offset identified in (12) described above. Thus, all the chunks forming the file corresponding to the stub file as the read target (at least the large chunk in the large and small chunks) are stored in the memory 213. The file system management unit 303 transmits the file including the chunks to the host 200 that has issued the read request.

The embodiment is as described above.

In the embodiment described above, one of the single stage deduplication and the two stage deduplication is selected in accordance with a file format of a backup file. Thus, the deduplication processing can be efficiently executed, and backup processing time and the deduplication rate can both be improved. The primary deduplication processing is executed first. Thus, the amount of data transferred from the front-end storage apparatus 100A to the back-end storage apparatus 100B, and a network transmission amount in the migration processing can be reduced.

The present invention is not limited to one embodiment described above. For example, whether a file is the specific file may be determined before the write processing for the file starts.

### REFERENCE SIGNS LIST

100 storage apparatus
200 host

1. A storage system comprising:
one or more storage areas; and
a control unit configured to execute primary deduplication processing and secondary deduplication processing,
the control unit being configured to, in the primary deduplication processing, divide a file into a plurality of large chunks, and determine, for each of the large chunks, whether a large chunk duplicated with a comparative target large chunk is stored in a second storage area that is one of the one or more storage areas, or in a first storage area that is a storage area different from the second storage area among the one or more storage areas,
the control unit being configured to, in the secondary deduplication processing, divide at least one large chunk into a plurality of small chunks, determine, for each of the small chunks, whether a small chunk duplicated with a comparative target small chunk is stored in the second storage area, and write the comparative target small chunk to the second storage area if the determination result is false,
the control unit being configured, when executing only the primary deduplication processing of the primary deduplication processing and the secondary deduplication processing, to store a large chunk that is not duplicated with a large chunk stored in the first or the second storage area, in the first or second storage area, and
the control unit being configured to execute the primary deduplication processing regardless of a file format, and not to execute the secondary deduplication processing when the file format satisfies a predetermined condition but execute the secondary deduplication processing when the file format does not satisfy the predetermined condition.

2. The storage system according to claim 1, wherein
the first storage area is a storage area provided to a transmission source host of the file, and
the control unit is configured to, in write processing for the file and for each of the plurality of large chunks forming the file,
execute the primary deduplication processing and
write a large chunk that is determined not to be duplicated in the primary deduplication processing, to the second storage area without executing the secondary deduplication processing, when the file format satisfies the predetermined condition.

3. The storage system according to claim 1, wherein
the first storage area is a storage area provided to a transmission source host of the file,
the control unit is configured to, in write processing for the file and for each of the plurality of large chunks forming the file,
execute the primary deduplication processing and
store, in the first storage area, a large chunk that is determined not to be duplicated in the primary deduplication processing, and
the control unit is configured to, asynchronously with the write processing for the file,
migrate a large chunk in the first storage area to the second storage area without executing the secondary deduplication processing when the file format satisfies the predetermined condition, and
execute the secondary deduplication processing on a large chunk in the first storage area when the file format does not satisfy the predetermined condition.

4. The storage system according to claim 1, wherein
the first storage area is a storage area provided to a transmission source host of the file,
the control unit is configured to, in write processing for the file, write the file to the first storage area, and
the control unit is configured to, asynchronously with the write processing for the file and for each of the plurality of large chunks forming a file in the first storage area,
execute the primary deduplication processing,
write a large chunk that is determined not to be duplicated in the primary deduplication processing, to the second storage area without executing the secondary deduplication processing when the file format satisfies the predetermined condition, and
execute the secondary deduplication processing on the large chunk that is determined not to be duplicated in the primary deduplication processing when the file format does not satisfy the predetermined condition.

5. The storage system according to claim 1, wherein
the first storage area is a storage area provided to a transmission source host of the file,
the control unit is configured to, in write processing for the file and for each of the plurality of large chunks forming the file,
execute the primary deduplication processing,
write a large chunk that is determined not to be duplicated in the primary deduplication processing, to the second storage area without executing the secondary deduplication processing when the file format satisfies the predetermined condition, and
write the large chunk that is determined not to be duplicated in the primary deduplication processing, to the first storage area without executing the secondary deduplication processing when the file format does not satisfy the predetermined condition, and
the control unit is configured to, asynchronously with the write processing for the file, execute the secondary deduplication processing on the large chunk in the first storage area.

6. The storage system according to claim 1, wherein the case in which the file format satisfies the predetermined condition is a case in which a format of the file corresponds to a file format that is defined to have a low deduplication effect.

7. The storage system according to claim 1, wherein the case in which the file format satisfies the predetermined condition is a case in which a format of the file corresponds to a file format that is defined to be compressed and to have a high update frequency.

8. The storage system according to claim 1, wherein the case in which the file format satisfies the predetermined condition is a case in which a format of the file corresponds to a file format of a compressed file, an image file, a log file, or a dump file.

9. The storage system according to claim 1, wherein a large chunk to be a target of the secondary deduplication processing is a large chunk determined not to be duplicated in the primary deduplication processing.

10. The storage system according to claim 1, wherein
the control unit is configured to compress each of the small chunks in the secondary deduplication processing, and
the compressed small chunks are stored in the second storage area.

11. The storage system according to claim 1, wherein
the control unit is configured to compress each of the large chunks in the primary deduplication processing, and
the compressed large chunks are stored in the first or the second storage area.

12. The storage system according to claim 1, wherein
the first storage area is a file system provided to a host apparatus, and
the second storage area is a file system hidden from the host apparatus.

13. The storage system according to claim 1, further comprising:
a first storage apparatus that includes a first storage control unit configured to perform the primary deduplication processing; and
a second storage apparatus that includes a second storage control unit configured to perform the secondary deduplication processing and is coupled to the first storage apparatus,
wherein the control unit includes the first and second storage control units.

14. A deduplication control method comprising:
executing primary deduplication processing on a file regardless of a format of the file;
not executing secondary deduplication processing when the file format satisfies a predetermined condition but executing the secondary deduplication processing when the file format does not satisfy the predetermined condition;
in the primary deduplication processing, dividing a file into a plurality of large chunks, and determining, for each of the large chunks, whether a large chunk duplicated with a comparative target large chunk is stored in a second storage area that is one of one or more storage areas, or in a first storage area that is a storage area different from the second storage area among the one or more storage areas; and
in the secondary deduplication processing, dividing at least one large chunk into a plurality of small chunks, determining, for each of the small chunks, whether a small chunk duplicated with a comparative target small chunk is stored in the second storage area, and writing the comparative target small chunk to the second storage area if the determination result is false.
